(19) United States
(12) Patent Application Publication
(10) Pub. No.: US 2016/0338330 A1
(43) Pub. Date: Nov. 24, 2016

(54) Fishing Lure

(71) Applicant: Bruce Norman Bendel, Rapid City, SD (US)

(72) Inventor: Bruce Norman Bendel, Rapid City, SD (US)

(21) Appl. No.: 15/106,583

(22) PCT Filed: Dec. 22, 2014
(86) PCT No.: PCT/US14/71914

§ 371 Date: Jun. 20, 2016

Related U.S. Application Data
(60) Provisional application No. 61/919,175, filed on Dec. 20, 2013.

(51) Int. Cl. A01K 85/18; A01K 91/04

(52) U.S. Cl. CPC A01K 85/18; A01K 91/04

(57) ABSTRACT

A fishing lure includes a lure body itself including a tail section and a head section. The head section includes a line attachment system for coupling fishing line or other tackle to the front of the lure which provides both increased structural competency and degrees of freedom for motion of the lure as it travels through water. The tail section includes an attachment mechanism for reversibly attaching a trailing leader line and trailing lure which can increasingly entice fish to strike the lure.

### CROSS REFERENCE TO RELATED APPLICATIONS

This application claims priority to and the benefit of U.S. Provisional Patent Application No. 61/919,175, filed on Dec. 20, 2013, the entire contents of which are incorporated by reference as if fully set forth herein.

### TECHNICAL FIELD

This disclosure relates fishing lures. In particular, this disclosure relates to fishing lures that include multiple parts that are operably attached to each other to present realistic action in the water.

### BACKGROUND

It has been recognized that a person's proficiency when fishing can be significantly improved by using lures that replicate the shape and/or swimming motion of real fish. In this regard, a number of fishing lures have been developed. One such lure is disclosed in U.S. Pat. No. 7,059,080.

### SUMMARY

In general, a fishing lure is disclosed. In one embodiment, a fishing lure includes a lure body and a trailing lure connected via a trailing leader line that is operably attached to the lure body. As the fishing lure is pulled through the water, the fishing lure exhibits movement that replicates the movement of an actual fish, which is thereby effective to entice fish to strike the lure.

In one exemplary aspect, a fishing lure is disclosed. The fishing lure includes a main lure body that includes head and tail sections and a line attachment system substantially disposed within the main lure body. The line attachment system includes first and second juts formed from a length of wire, a first attachment ring, a second attachment ring, and a third attachment ring. A portion of the first and second juts protrudes from a forward portion of the head section. Additionally, the first attachment ring loops through the first jut, the second attachment ring loops through the second jut, and the third attachment ring loops through the first attachment ring and the second attachment ring.

In one embodiment, the line attachment system further includes a third jut. In a related embodiment, the third jut protrudes from a neck portion adjacent the head section of the main lure body.

In one embodiment, the wire is configured as a continuous loop.

In one embodiment, the wire is formed of metal.

In one embodiment, the head section comprises a forwardly-positioned, substantially C-shaped diving bill configured to engender erratic motion of the lure when pulled through water. In a related embodiment, the substantially C-shaped diving bill includes facets configured to divert water in a selected direction when the lure is pulled through water. In one embodiment, the diving bill includes adjacent upper and lower portions, and the first and second juts are configured to protrude from a concave surface of the substantially C-shaped diving bill.

In one embodiment, the third ring is configured as a line-to-lure attachment member, and the third jut is configured to receive a lure accessory.

In one embodiment, the lure body further includes a first hollow bore within the tail section that extends to an end portion of the lure body and is configured to receive a portion of a trailing leader line. In one embodiment, the section further includes a second bore that bisects the first bore and is configured to receive a locking pin therethrough that itself is configured for attaching the trailing leader line to the tail section. In one embodiment, a distal end portion of the trailing leader line includes a closed loop configured to receive the locking pin therethrough. In one embodiment, the trailing leader line is formed of a core material overcoated with a second, different material along its length. In a related embodiment, the core material is seven-strand wire, and the second material is a synthetic polymer.

In one embodiment, the trailing leader line includes, at a distal end portion, at least one protuberance, and the tail section further includes a hollow void in communication with the first hollow bore, wherein the hollow void has a substantially complementary shape to that of the at least one protuberance and is configured to receive the at least one protuberance therein. In one embodiment, the protuberance is a resiliently-flexible barb. In one embodiment, the resiliently-flexible barb is capable of shifting from a first, outwardly-splayed configuration in which the distal end portion of the trailing leader line can be lockingly engaged with the tail section, to a second, inwardly biased configuration that allows the distal end portion of the trailing leader line to be disengaged from the tail section.

In another exemplary aspect, a method of making a fishing lure is disclosed. The method includes providing a fishing lure body and a line attachment system, where the line attachment system includes first and second juts formed from a length of wire. The method further includes configuring the line attachment system substantially within the lure body such that a portion of the first jut and the second jut protrude from a forward portion of the lure body.

In one embodiment, the line attachment system further includes first, second, and third rings, wherein the first ring loops through the first jut, the second ring loops through the second jut, and the third ring provides a line-to-lure attachment member that loops through the first and the second ring.

In yet another exemplary aspect, a fishing lure is disclosed. The fishing lure includes a lure body, an attachment mechanism for attaching fishing line to the lure that engenders erratic motion of the lure when pulled through water by the fishing line, and an attachment mechanism for reversibly attaching a trailing leader line to a tail section of the lure.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, or in a priority document, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 is an isometric view of a fishing lure according to one illustrative embodiment;

FIG. 2 is a side view of a line-connection system according to one illustrative embodiment;

FIG. 3 is a cross-sectional side view of the fishing lure shown in FIG. 1, according to one illustrative embodiment;

FIG. 4 is a front view of the fishing lure shown in FIG. 1, according to one illustrative embodiment;

FIG. 5 is a bottom view of the fishing lure shown in FIG. 1, according to one illustrative embodiment;

FIG. 6 is a right side view of the fishing lure shown in FIG. 1, according to one illustrative embodiment;

FIG. 7 is a top view of the fishing lure shown in FIG. 1, according to one illustrative embodiment;

FIG. 8 is a rear view of the fishing lure shown in FIG. 1, according to one illustrative embodiment;

FIG. 9 is a left side view of the fishing lure shown in FIG. 1, according to one illustrative embodiment;

FIG. 10 is a cross-sectional view of a fishing lure having a trailing leader line coupled to the tail section, according to one embodiment;

FIG. 11 illustrates coupling of a trailing leader line to the tail section of a fishing lure, according to one embodiment; and

FIG. 12 illustrates an alternative mechanism for coupling a trailing leader line to the tail section of a fishing lure, according to one embodiment.

### DETAILED DESCRIPTION OF ILLUSTRATIVE EMBODIMENTS

In general, fishing lures (hereinafter ‘lures’) are disclosed which exhibit pronounced life-like action when traveling through water. In some embodiments, the lure includes an integrated line-attachment system (hereinafter “LAS”) that provides one or more mechanisms by which to attach fishing line to the lure. In one aspect, the LAS enables the lure to exhibit pronounced life-like action by providing additional degrees of freedom for the attachment point between line and lure. In various embodiments, the LAS can be coupled to the lure body in such a way as to provide high strength and reliability for the line-to-lure connection which reduces the likelihood of lost fish due to structural failure of the lure or line attachment mechanisms. Furthermore, the configuration of the LAS provides the ability to couple other lure accessories, e.g., tackle, beneath the lure body for increased visibility or for providing attachments that stimulate fish to strike the lure. Furthermore yet, in some embodiments, a fishing lure includes a tail section that is configured to receive a reversibly interlocking trailing leader line for dragging additional lure components or accessories behind the lure to entice fish to strike.

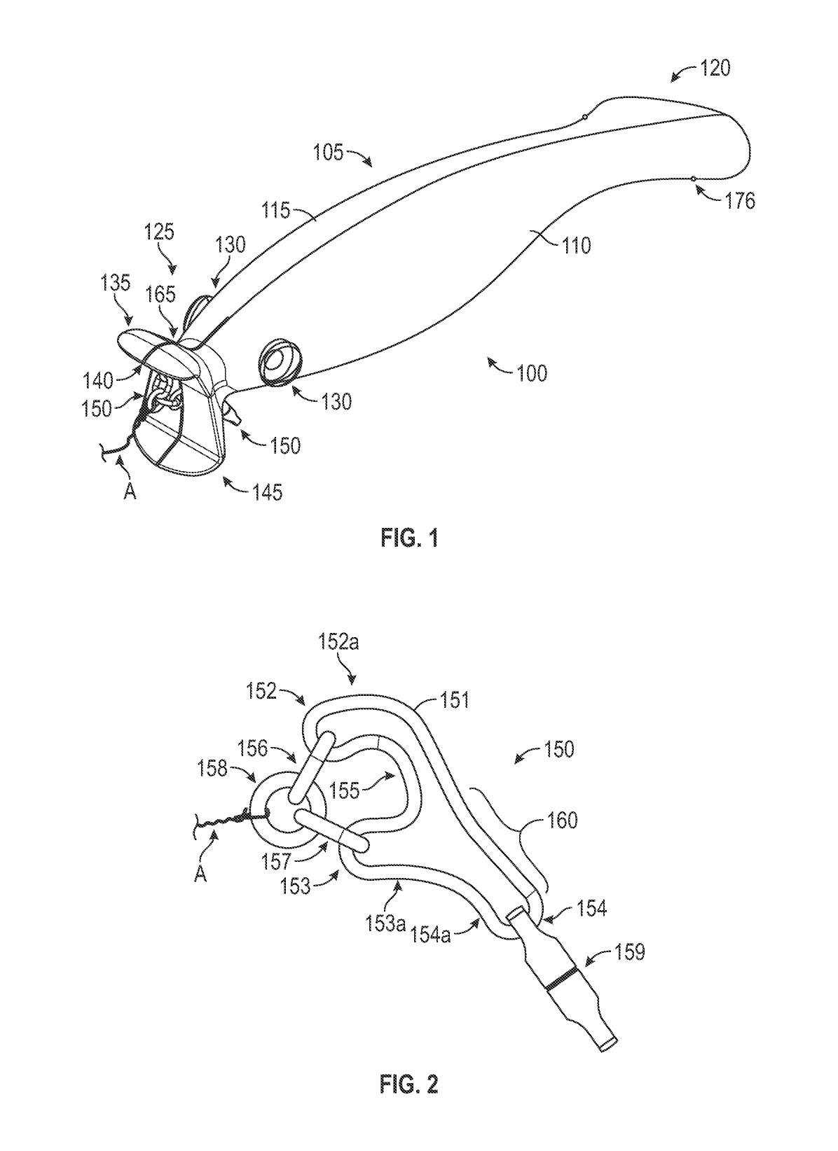

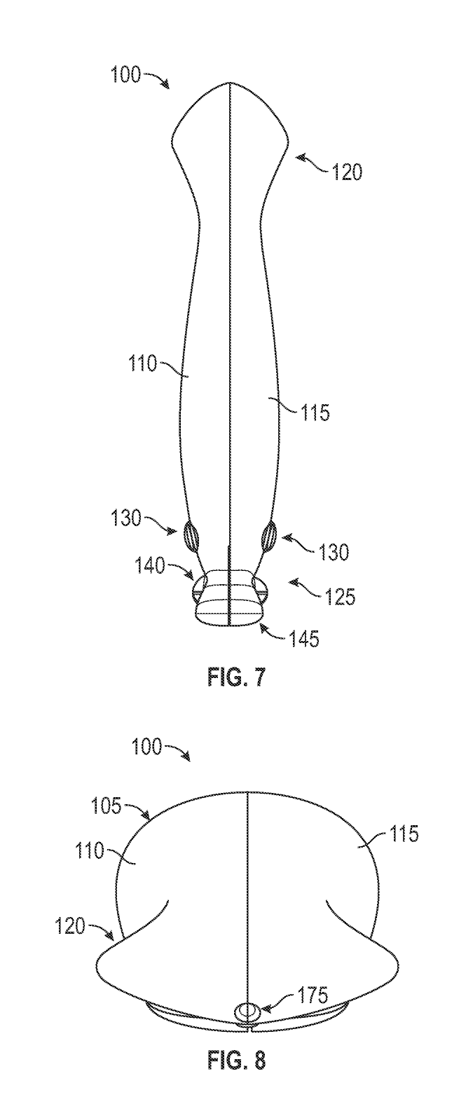

Referring now to FIGS. 1-9, a fishing lure (hereinafter “lure”) 100 is shown in various views according to one illustrative embodiment. Referring first to FIG. 1, in this embodiment, the lure 100 includes a main lure body 105 (hereinafter “lure body”) formed from the engagement of left and right body halves 110, 115 respectively, as illustrated. In this embodiment, the lure body 105 is continuous along its longitudinal axis (the z-axis in FIG. 4) and includes a tail section 120 and a head section 125. In this embodiment, the lure has a general shape of a “crankbait” or “plug;” however, the lure body 105 can be formed into any desired shape which may depend on the type of fish sought after by using the lure. Additionally, the lure body 105 can be configured as a two-piece lure having at least one connection mechanism therebetween, similar to “jointed” lures offered by, e.g., Rapala VMC Corporation, having headquarters in Helsinki, Finland.

In this embodiment, the lure 100 is adorned with eyes 130 to resemble, e.g., a bait fish. In this and other embodiments, the lure 100 can include any variety of adornments, colors, markings, or other features as desired. For example, any part of the lure 100 can include striping, reflective surfaces, grooves, channels, scalloped etchings, colors or other indicia that can increase or enhance the effectiveness of the lure 100 in enticing fish to strike at it.

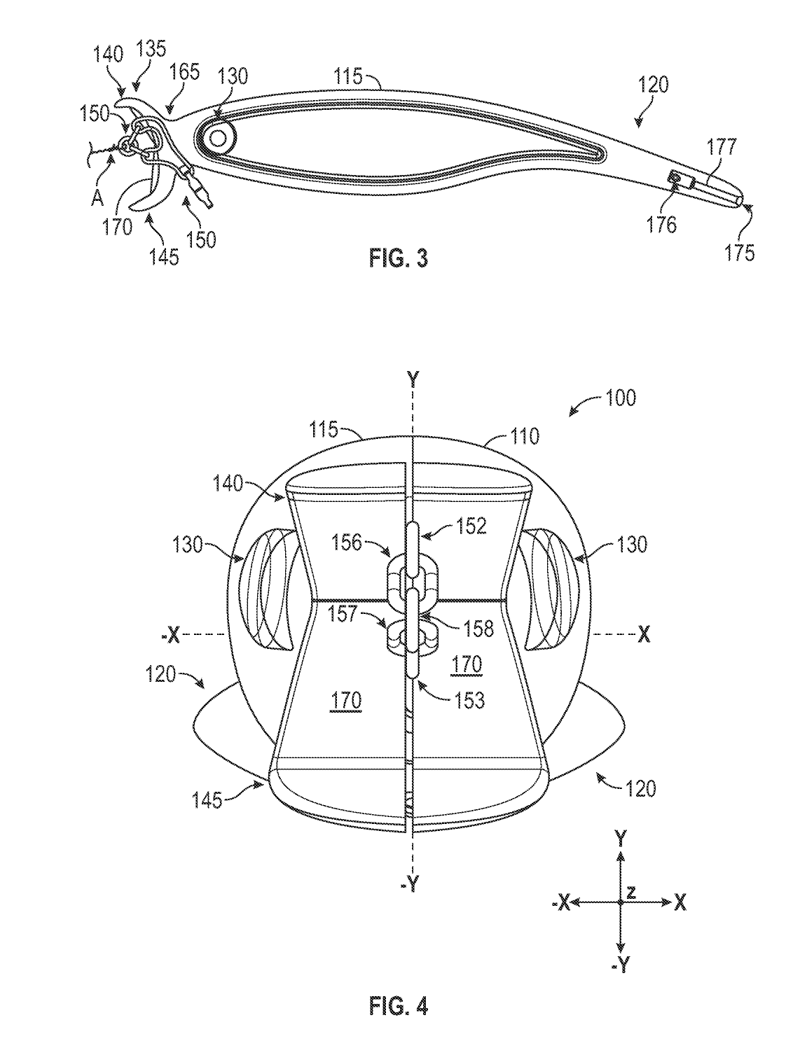

In this embodiment, the head section 125 includes a substantially C-shaped, faceted diving bill 135 formed of upper (140) and lower (145) portions as illustrated (see, e.g., the cross-sectional side view illustrated in FIG. 3). The diving bill 135 can cause the lure 100 to move erratically when pulled through water according to its size, shape and other features, each of which can be modified to suit particular fishing preferences. For example, in this embodiment, the upper portion 140 has smaller dimensions than the lower portion 145, which can cause the lure 100 to dive as it is pulled through the water. Conversely, the lure 100 can be made to stay closer to the surface when pulled through water if the upper portion 140 has larger dimensions than the lower portion 145. As many anglers recognize, crankbaits that exhibit erratic motion when pulled through the water often entice fish to strike as they resemble injured prey.

In one embodiment (not shown in FIGS. 1-9), the diving bill 135 can be reversibly-rotatable about the longitudinal axis (e.g., the z-axis as illustrated in FIG. 4) allowing the positions of the upper (140) and lower (145) portions to be swapped as desired. Such a feature can be useful in that an angler can use a single lure, e.g., when fishing in waters having variable terrain or underwater vegetation to avoid obstacles or snags. In such an embodiment, the diving bill 135 can be connected to the lure body 105 via an elastic cord, spring, or similar mechanism which allows the diving bill 135 to be pulled away from the lure body 105, rotated, and set back into a desired position. Additionally or alternatively, the diving bill 135 can be operably connected to the lure body 105 via a toothed clutch, gear, sprocket, or other system to allow rotation about the longitudinal axis as desired.

Referring to FIGS. 2 and 3 in particular, in this embodiment, the lure 100 includes a LAS 150. In the interest of clarity, FIG. 2 depicts the LAS 150 by itself, according to one embodiment; FIG. 3 is a cross-sectional view illustrating an operational position of the LAS 150 within the lure 100 according to one embodiment. (FIG. 3 shows the LAS position with respect to the right body half 115; the left body half 110 has been removed for clarity of the illustration.)

In this embodiment, the LAS 150 provides at least one attachment point to which fishing line “A” can be coupled to the lure body as described in greater detail below. It should be understood that line-to-lure connection preferences vary widely among anglers, and that such attachment can be made additionally utilizing leaders, swivels, or other tackle as desired and without limitation.

In this embodiment, the LAS 150 includes a length of resilient wire 151 configured as a continuous loop as illustrated, e.g., in FIG. 2. It should be understood that “wire” can represent any number of resilient, formable materials, e.g., metals, alloys, etc. that can be used for the intended purpose described herein. Furthermore, some high-strength plastics can be used, e.g., in place of metal or metal alloy wire. In this embodiment, the wire 151 is formed so as to provide juts, e.g., first jut 152a, second jut 153a and third jut 154a that extend outwardly so as to provide, a first half-loop 152, a second half-loop 153, and a third half-loop 154 respectively, as illustrated. In some LAS embodiments, the wire 151 can be configured to provide only first (152a) and second (153a) juts if the functionality provided by the third jut 154a and third half-loop 154 (described herein) is not desired. When the LAS 150 is positioned in the lure in an operational configuration, e.g., as illustrated in FIGS. 1 and 3, the first (152) and second (153) half-loops protrude in part from a forward surface 170 of the diving bill 135 as illustrated. In this embodiment, the LAS 150 includes a ring assembly that includes a first attachment ring 156, a second attachment ring 157, and a third attachment ring 158 as illustrated. The first attachment ring 156 provides a linkage between the first half-loop 152 and the third attachment ring 158, and the second attachment ring 157 provides a linkage between the protruding second half-loop 153 and the third attachment ring 158 as illustrated. Fishing line “A” or other tackle can be attached, e.g., to the third attachment ring 158, thereby providing a line-to-lure attachment, and enabling an angler to cast and retrieve the lure 100 as desired.

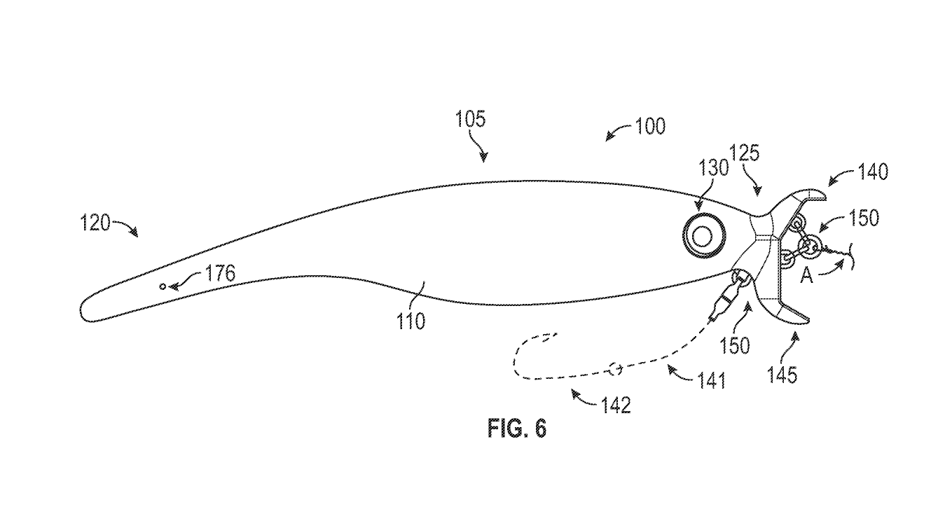

In this embodiment, the LAS 150 includes elongate portion 160 which, when the LAS 150 is in an operable configuration as depicted in FIGS. 1 and 3, provides that the third half-loop 154 protrudes in part from a lower portion of a neck portion 165 of the lure 100 as illustrated. The protruding third half-loop 154 can be used for attaching any desired fishing tackle, lure components, trailing bait, so-called “anti-weed” mechanisms, or other accessories to increase the effectiveness of the lure 100 for catching fish. FIGS. 1-9 depict attachment of an “Aussie swivel” to the third half-loop 154 for illustrative purposes. A leader 141 and hook 142 operably coupled to the Aussie swivel are illustrated in FIG. 6 in dashed lines to indicate one of many possible alternatives for coupling fishing tackle accessories to the LAS 150.

In various embodiments, the LAS 150 can be made of any desired material to provide requisite strength and endurance for various types of fish and/or fishing. For example, lure 100 can be sized as appropriate for bass fishing using a certain gauge wire, e.g., 25 AWG; however, the LAS 150 in lures sized for larger fish such as the Marlin species can utilize a much heavier-gauge wire such as 15 or 10 AWG. In one embodiment, the various components of the LAS 150 can be formed from 0.072-gague, stainless steel wire. Furthermore, while the LAS 150 illustrated in FIGS. 1-9 utilizes a three-ring system (e.g., attachment rings 156, 157, 158), it should be understood that in alternative embodiments, a LAS can include more or fewer rings arranged as desired for modifying the action of the lure as it travels through water.

In general, the LAS 150 provides a high-strength line-to-lure connection. In a first aspect, in this embodiment, the LAS 150 can be formed from high-strength material in a closed-loop configuration which greatly reduces the likelihood that the wire 151 or attachment rings 156, 157, 158 will break or fail, as compared, e.g., to split-ring systems or eyelets screwed directly into the lure. LAS 150 can be manufactured, in one approach, by first forming wire 151 in the general shape as shown, e.g., in FIG. 2; prior to closing the loop, however, the three ring assembly including attachment rings 156, 157, 158 can be slid onto wire 151 and positioned onto first and second half-loops 152, 153 as illustrated. The wire 151 can then be closed, e.g., with a high-strength weld to form the closed-loop system.

In a second aspect, in this embodiment, the LAS 150 can be integrated into the body 105 of the lure 100 such that only the first, second, and third half-loops (152, 153, 154) protrude therefrom, as illustrated. Such a configuration provides increased reliability in that the three-ring system (e.g., attachment rings 156, 157, 158) is effectively integrated into the relatively large, continuous, internally-disposed wire 151 rather than connecting to individual eyelets, for example. In other words, considering the line-to-lure connection, forces imparted to the LAS, e.g., when a fish strikes, are spread throughout the head section 125 as opposed to forces at “point” connections if, e.g., the line-to-lure connection utilized individual eyelets. Furthermore, such a configuration provides a significant ease-of-manufacturing advantage in at least that individual line-to-lure connection parts need not be welded or screwed into the lure body 105, which is often the case for lures utilizing eyelets for the lure-to-line connection, for example.

In the instant case, to operably integrate the LAS 150 into the lure body 105, the LAS 150 can be placed into position (e.g., as shown in FIG. 3) and fixed to one of the lure body halves, e.g., right body half 115 by any desired method, e.g., gluing, welding, soldering, or other methods. Subsequently, the other lure body half, e.g., left body half 110 can be placed in a confronting relationship with the opposite half and fixedly coupled by desired methods, e.g., gluing, welding, soldering, or other methods such that the lure 100 resembles the operational configuration illustrated in, e.g., FIG. 1. In one embodiment, one half of the lure body 105, e.g., the right body half 115 can be formed by plastic injection molding techniques to include a recessed area that is complementary to the shape and of the wire 151 so that the wire 151 can be received therein. In an alternative embodiment, both body halves, e.g., left body half 110 and right body half 115 can each include one-half of a recessed area that is complementary to the shape and size of the wire 151 so that the position of the wire 151 is substantially centered between the two mating surfaces of the body halves.

Referring now to FIG. 4, in this embodiment, the LAS 150 provides translational degrees of freedom such that the lure 100 can move in erratic ways as it moves through the water, mimicking the behavior of a sick or injured fish. Such movement is known to attract other fish to strike; as, in nature injured fish are less adept in escaping a predator. In this embodiment, additional degrees of freedom in the motion of the lure body 105 are provided at least in part by the three-ring linkage assembly that includes attachment rings 156, 157, and 158.

FIG. 4 is a front-view of the lure 100 as viewed down the longitudinal axis (the z-axis in the illustrated Cartesian coordinate system). In this embodiment, attachment rings 156, 157, and 158 are free to shift relative to each other, wherein the extent of such shifting is principally determined by the size and thickness of each ring and their ability to shift relative to each other. For example, as the lure 100 moves through water, the lure body 105 is allowed to shift left and right, along the x-axis mainly by virtue of the amount of play provided by the third attachment ring 158. Similarly, the lure body 105 can shift up and down, along the y-axis mainly by virtue of the amount of play in the first and second attachment rings 156, 157. It should be understood that when the lure 100 is pulled through the water, e.g., by reeling in line, the lure is free to randomly move in all directions, which gives rise to the desired erratic movements.

Like other parts of the lure 100, in some embodiments, the diving bill 135 can include various design features for attracting fish, reducing drag, or other factors. In one example, any desired portion of the diving bill 135, the tail section 120, or the trailer leader edges (described herein) can include scalloped or serrated edges or surfaces. In one embodiment, the diving bill 135 can have a roughened surface. This roughened surface can be caused, e.g., by a texture on a mold used to manufacture the lure 100. Alternatively or additionally, the roughened surface can be formed by attaching an abrasive such as sand to the surface of the lure body. Such a process can provide the surface with a texture that is similar to sand paper.

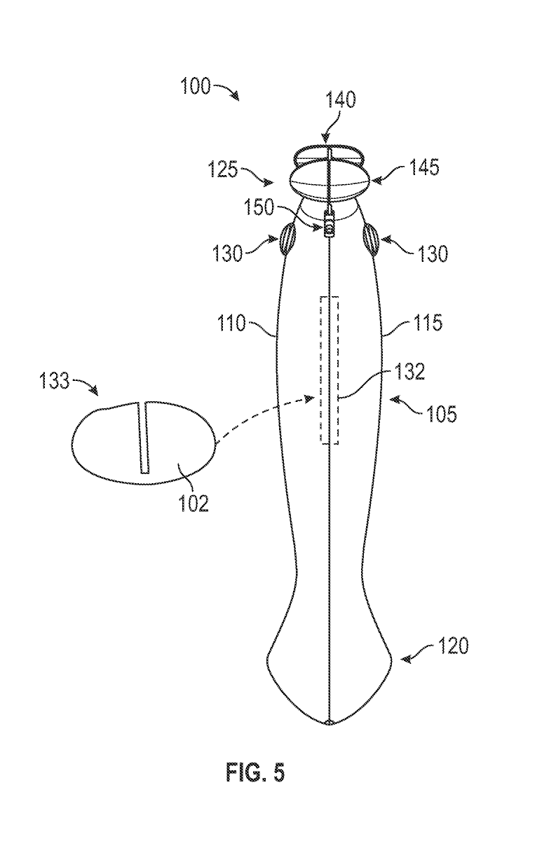

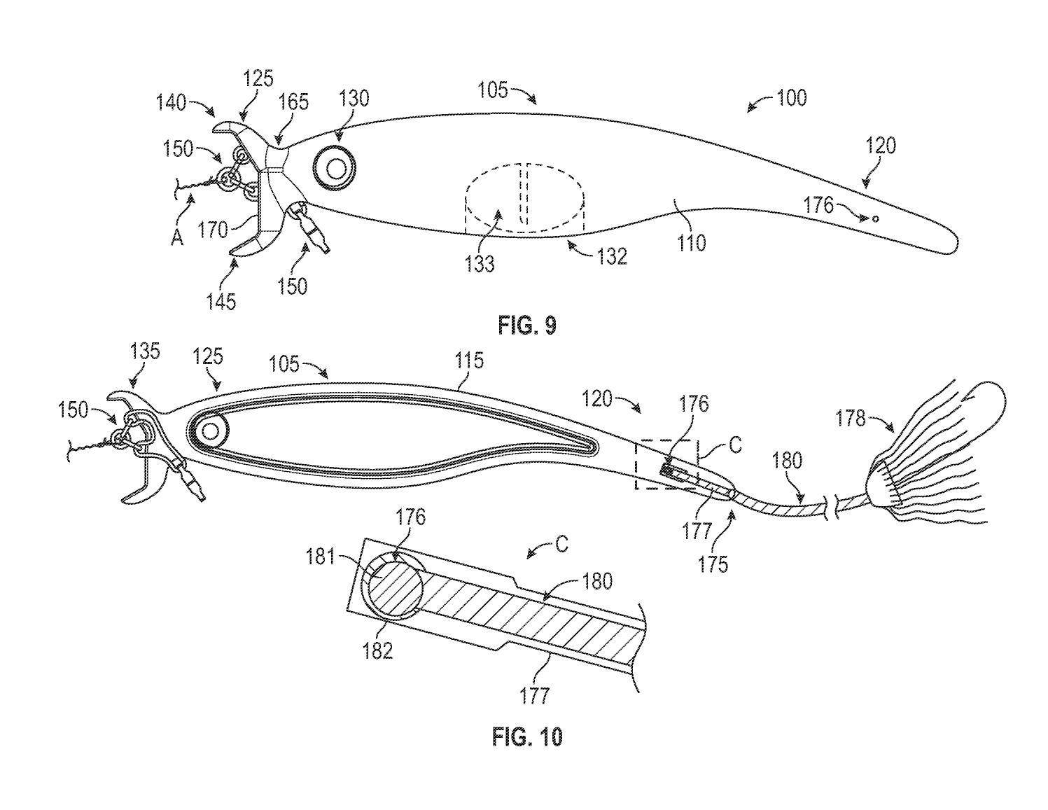

Referring now to FIGS. 5 and 9 in particular, in one embodiment, the lure body 105 can include one or more apertures for receiving lure weights. Lure weights can facilitate desired action and buoyancy of a lure when fishing in waters having different salinities, for example, or if the angler prefers to fish in upper or lower regions of a water body. FIG. 5 illustrates an exemplary weight aperture 132 configured to reversibly lockingly engage an exemplary lure weight 133. The lure weight 133 can be formed from dense materials to provide a desired amount of weight to the lure and can be offered, e.g., commercially in several weight alternatives. In general, the weight aperture 132 and the lure weight 133 can be cooperatively configured such that the lure weight 133 can be easily inserted and removed from the weight aperture 133, and so that when the weight 133 is inserted into the lure body 105, it is securely coupled thereto until the angler provides sufficient removal force to decouple the weight from the body.

In one embodiment, weight aperture 132 can be configured to receive one or more lure weights 133 and, additionally, ‘blank’ weight spacers (not illustrated) that have substantially the same form as a lure weight 133 but have a significantly reduced mass. For example, a blank weight can be formed of a lightweight synthetic polymer. Such a blank weight can be configured to take up any space within the weight aperture 132 not occupied by weights 133. Thus, in such an embodiment, a weight aperture 132 can have a width that is, for example, three times the width of a lure weight 133. In this example, an angler may need the weight of only one lure weight 133 to provide the desired buoyancy of the lure 100. The angler then insert the one lure weight 133 and two blank weight spacers to substantially fill the weight aperture 132 so that the underside of the lure body 105 appears substantially continuous, e.g., devoid of weight aperture 132.

FIGS. 5 and 9 illustrate weight aperture 133 configured along the longitudinal axis of the lure body 105; however, it should be understood that this is one of many optional configurations. For example, the weight aperture 133 illustrated in FIG. 5 can be rotated ninety degrees so that it is arranged substantially perpendicular to the longitudinal axis of the lure body 105; or, in one embodiment, a lure body 105 can include a plurality of weight apertures arranged perpendicular or parallel to each other. Furthermore, in one embodiment, the lure body 105 can include a plurality of weight apertures 133, e.g., arranged adjacently, so that the angler can fine-tune the amount of weight applied to the lure 100. Furthermore yet, in general, the one or more weight apertures can be positioned in the lure body 105 so as to affect one or more of the action and buoyancy of the lure in a desired way when weights are inserted therein. For example, in one embodiment, the one or more weight apertures can be located at, or substantially near the center of gravity of the lure so that their effect on lure action is minimized. Alternatively, in another embodiment, weight apertures can be located closer to the head (125) or tail (120) sections as desired to facilitate ‘tipping’ the lure up or down, thereby causing the lure to advance upwardly or downwardly, respectively, as it is pulled through the water.

Referring now to FIGS. 3, 6, 8, 9, and 10 in particular, in this embodiment the lure 100 is configured to receive a portion of trailing leader line 180. As is known in the art of angling, fish, especially aggressive species such as Marlin, can do damage to fishing line and tackle, and so it can be advantageous to provide the ability to change out damaged components quickly and easily. In this embodiment, the tail section 120 of the lure 100 includes an aperture 175 configured to receive a portion of trailing leader line 180. Referring in particular to FIG. 10, in this embodiment, the aperture 175 is at a distal end portion of a bore 177 that extends into the lure body 105. The distance that the bore 177 extends into the lure body 105 can be a matter of design choice taking into account, for example, the species of fish sought while using the lure, the strength, size, and material of the trailing leader line 180, and other factors.

Referring to magnified view “C” in FIG. 10, in this embodiment, the trailing leader line 180 extends through the bore 177 until it reaches aperture 176. Aperture 176 extends laterally through the lure body 105 from, e.g., right to left sides as illustrated and is configured to reversibly receive a locking pin 181 therethrough. In this embodiment, the trailing leader line 180 includes a ring-shaped distal end portion 182, wherein the ring portion has an open diameter at least as large as the diameter of the locking pin 181 so that the locking pin 181 can be inserted through both the ring-shaped distal end portion 182 and the aperture 176. Such a configuration provides the ability to reversibly lock the trailing leader line 180 in place within the tail section 120 and allows the trailing leader line 180 to be easily and quickly replaced should it become damaged, e.g., by a fish strike. In this and other embodiments, the length of the trailing leader line 180 can be selectively varied according to many considerations, including the type of fish sought after by use of the lure 100. Furthermore, the trailing leader 180 can include other lures, mechanisms, bait, or any other objects for attracting fish. In FIG. 10, an exemplary trailing lure 178 is shown for purposes of illustration.

A trailing leader line 180 can be coupled with the lure body 105 as follows. First, the locking pin 181 can be removed from aperture 176 if that is its starting location. Next, the distal end portion 182 of the trailing leader line 180 can be inserted into aperture 175, up through bore 177 until it reaches aperture 176. Next, the locking pin 181 can be inserted into aperture 176 such that it passes through the left body side 110, the distal end portion 182, and finally through the right body side 115. Such a configuration can lock the trailing leader line 180 in place as described. To decouple the trailing leader line 180, the reverse process can be performed. In this embodiment, the length of locking pin 181 is such that each terminal end of the pin is flush with the outer surface of the left and right body sides 110, 115 respectively when fully inserted and is also configured with color or other markings so that it blends in with the rest of the lure body 105.

In this and other embodiments, the trailing leader line 180 can be formed of any commercially-available material, including, but not limited to: monofilament, e.g., nylon or fluorocarbon; single strand wire, e.g., stainless steel, tinned or galvanized wire; or multi-strand cable, e.g., nylon coated or uncoated wire. In one embodiment, trailer leader 180 can include a first core material which is coated with one or more second materials which may or may not be different from the first material. For example, a trailing leader line 180 can include a core length of seven-strand wire. The seven-strand wire can be coated with one or more layers of a laminate nylon material until it is of desired cross-sectional thickness. Such a trailing leader line configuration can provide flexibility for the desired amount of action by the trailing lure 178 as it is pulled through the water while simultaneously providing resilience against fish strikes that may otherwise break the trailing leader line 180.

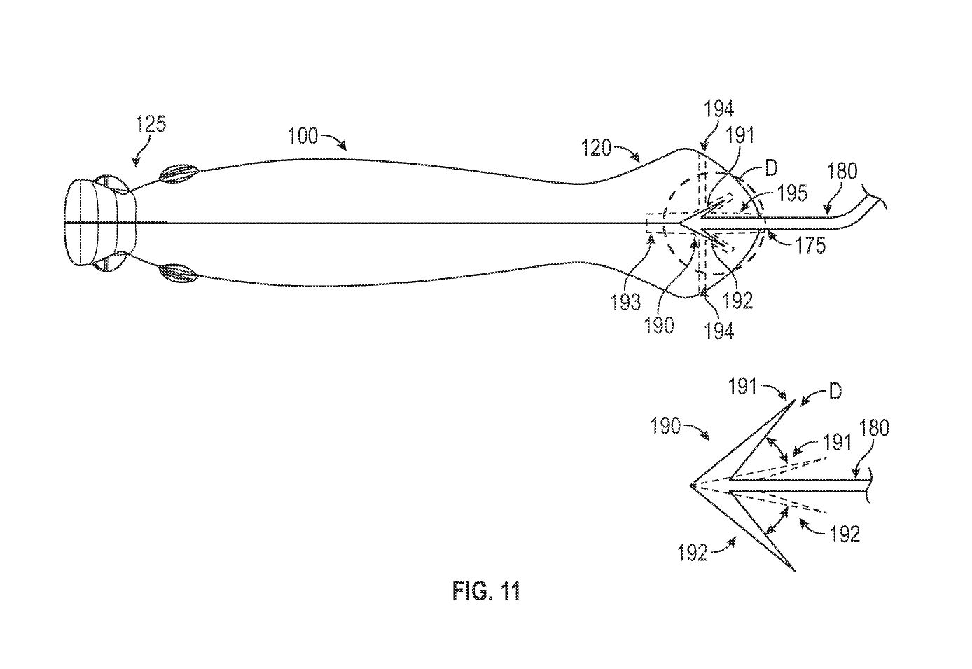

FIG. 11 is a top-view of lure 100 illustrating an alternative embodiment where tail section 120 is configured to reversibly couple to a trailing leader line 180, wherein a distal end portion of the trailing leader line 180 includes at least one protuberance such as a barb, hook, arm, finger, jut, or other member that extends outwardly from the main body of the trailing leader line 180. FIG. 11 illustrates the distal end portion of trailing leader line 180 having an arrow-shaped distal end portion 190 including barbs as exemplary protuberances. In this embodiment, the arrow-shaped distal end portion 190 includes first (191) and second (192) barbs which are resiliently flexible such that they can shift between first and second configurations. Referring to the magnified section “D” in FIG. 11, the distal end portion 190 is shown in a first configuration (dark shading) where the barbs 191, 192 are outwardly splayed and a second configuration (dashed lines) where the barbs 191, 192 are shifted inward toward each other.

Referring now to the tail section 120 in FIG. 11, in this embodiment, the tail section 120 includes aperture 175 that leads into an arrowhead-shaped channel void (dashed lines) 193 which has a complementary shape and size to that of the distal end portion 190 of the trailing leader line 180.

FIG. 11 illustrates the trailing leader line 180 in a locked configuration with the tail section 120 of the lure 100. As such, the barbs 191, 192 are received by the similarly-shaped triangular-shaped features of channel void 193 which substantially prevents the trailing leader line 180 from backing out of the lure body 105. To engage the trailing leader line 180 to the lure body 105, the arrowhead-shaped distal end portion 190 can be inserted into aperture 175. As the distal end portion 190 is advanced through the passageway 195 the barbs 191, 192 are urged inward, toward each other due to the restricted passageway area. Once the barbs 191, 192 reach the triangular-shaped features of channel 193, they resiliently splay outward; the trailing leader line 180 can then be pulled slightly backward to fully engage the barbs 191, 192 of distal end portion 190 within the arrowhead-shaped channel void 193.

As mentioned, it can be advantageous to swap out trailing leader line 180 when desired. To facilitate such functionality, the tail section 120 includes a lateral channel 194 that bisects the arrowhead-shaped channel void 193 and is configured to receive a pin, dowel, or other similar object therethrough (not shown). To remove the trailing leader line 180 from the tail section 120, the distal end portion 190 can be advanced toward the head section 125 of the lure body 105. At this point, pins e.g., can be inserted into channel 194 from opposite sides to urge barbs 191, 192 toward each other. Subsequently, with the barbs in such a configuration, the trailing leader line 180 can be backed out of passageway 195 and completely decoupled from the lure body 105.

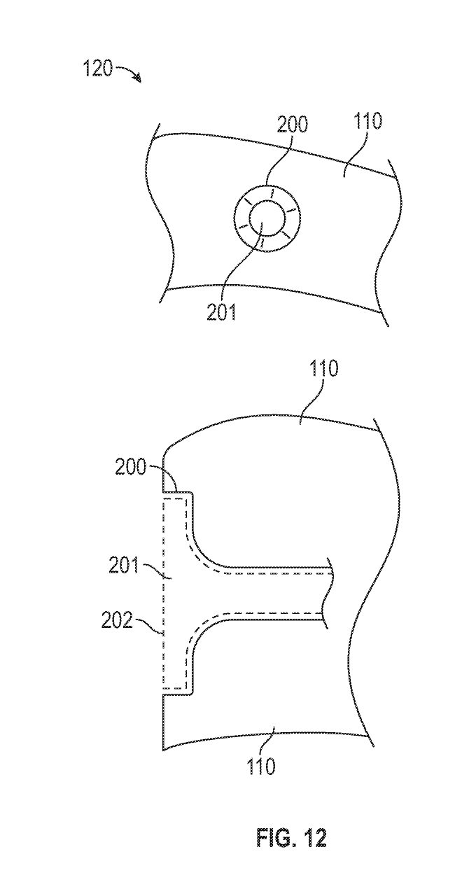

Referring now to FIG. 12, one alternative attachment mechanism for securing the distal end of a trailing leader line 180 in the tail section 120 is illustrated according to one embodiment. In FIG. 12, the upper portion illustrates a side view of the tail section 120 and the lower portion illustrates a cross-sectional view of the tail section 120 perpendicular to the longitudinal axis of the lure body 105. In this embodiment, as an alternative to the sole use of a locking pin 181, the attachment mechanism includes a bushing 200 and a complimentary post member 201 configured to reversibly fit securely therein. In this example, the bushing 200 is a flanged sleeve configured within the tail section 120 such that it extends at least partially therethrough. The sleeve can be, e.g., a solid or split sleeve as desired. In this example, the bushing is configured at or near the location of aperture 176 previously described and extends through the tail section 120 substantially perpendicular to the longitudinal axis of the lure 100, although other configurations can be selected according to preference. In this embodiment, the post member 201 (shown in dashed lines in FIG. 12) has a correspondingly flanged shape, as illustrated, and is configured such that when the post member 201 is fully inserted into bushing 200, minimal space exists therebetween and a top surface 202 of the post member 201 is flush with the exterior surface of the lure body 105. (FIG. 12 illustrates top surface 202 flush with left body side 110 in this example.) The post member 201 can be formed of any desired material, including, without limitation, those described herein with respect to locking pin 181. Furthermore, post member 201 is configured for functional equivalence to locking pin 181 in that it serves to reversibly secure a distal end portion of a trailing leader line within the tail section 120, e.g., as described herein for locking pin 181. In one embodiment, the inner diameter of the bushing 200 can be configured with a diameter slightly less than the diameter of the post member 201 such that the post member 201 is frictionally engaged with the bushing 200 when inserted therein.

It should be understood that the aforementioned alternative tail section embodiment has been described and illustrated using one exemplary trailer leader distal end portion 190 and channel 193 configuration and other alternative configurations are equally contemplated.

In the preceding description, reference is made to the accompanying drawings, which form a part hereof, and in which is shown by way of illustration specific embodiments in which a fishing lure is described. In this regard, directional terminology, such as “top,” “bottom,” “front,” “back,” “upper,” “lower,” “forward,” “leading,” “trailing,” etc., is used with reference to the orientation of the Figure(s) being described. Because components of embodiments can be positioned in a number of different orientations, the directional terminology is used for purposes of illustration and is in no way limiting.

A number of illustrative embodiments have been described. Nevertheless, it will be understood that various modifications may be made without departing from the spirit and scope of the various embodiments presented herein. For example, the interior of the lure body 105 can include chambers, bladders, or other enclosures for storing a volume of air to provide a desired amount of lure buoyancy. With reference to FIG. 10 in particular, locking pin 181 can be formed of a suitable material to be inserted into the lure body 105 to both retain the trailing leader within the tail section 120 and also substantially prevent water from entering the aperture 176. In one embodiment, the locking pin 181 can be formed in whole or in part of a synthetic polymer such as an aliphatic polyamide, with Nylon 6/6 being a preferred, but non-limiting material; another preferred material includes an acetal homopolymer such as DELRIN® provided by DuPont; yet another preferred material includes polyethylene; other compounds will be apparent to those skilled in the art. In some embodiments, water-resistant compounds such as caulks or putties can be used to seal the locking pin 181-aperture 176 interface. The lure body 105 can be formed with a length that is selected based upon the type and size of fish that is intended to be caught using the lure 100. In certain embodiments, the lure body 105 has a length between about three inches and about 24 inches. In other embodiments, the lure body 105 has a length between about 10 inches and about 14 inches. The other dimensions of the lure body 105 can be selected according to preference and proportionately based on the selected length. Accordingly, other embodiments are within the scope of the following claims.

What is claimed is:

1. A fishing lure, comprising:
a main lure body comprising head and tail sections;
a line attachment system substantially disposed within said main lure body, comprising: first and second juts formed from a length of wire, a first attachment ring, a second attachment ring, and a third attachment ring;
wherein a portion of said first and second juts protrudes from a forward portion of said head section; and
wherein said first attachment ring loops through said first jut, said second attachment ring loops through said second jut, and said third attachment ring loops through said first attachment ring and said second attachment ring.

2. The fishing lure of claim 1, wherein said line attachment system further comprises a third jut.

3. The fishing lure of claim 2, wherein said third jut protrudes from a neck portion adjacent said head section of said main lure body.

4. The fishing lure of claim 1, wherein said wire is configured as a continuous loop.

5. The fishing lure of claim 1, wherein said head section comprises a forwardly-positioned, substantially C-shaped diving bill configured to engender erratic motion of said lure when pulled through water.

6. The fishing lure of claim 5, wherein said substantially C-shaped diving bill comprises facets configured to divert water in a selected direction when said lure is pulled through water.

7. The fishing lure of claim 5, wherein said diving bill comprises adjacent upper and lower portions, and said first and second juts are configured to protrude from a forward surface of said substantially C-shaped diving bill.

8. The fishing lure of claim 2, wherein said third ring is configured as a line-to-lure attachment member, and said third jut is configured to receive a lure accessory.

9. The fishing lure of claim 1, wherein said lure body further comprises a first hollow bore within said tail section that extends to an end portion of said lure body and is configured to reversibly receive a portion of a trailing leader line.

10. The fishing lure of claim 9, wherein said tail section further comprises a second bore that bisects said first bore and is configured to receive a locking pin therethrough, wherein said locking pin is configured for attaching said trailing leader line to said tail section.

11. The fishing lure of claim 0, wherein a distal end portion of said trailing leader line comprises a closed loop configured to receive said locking pin therethrough.

12. The fishing lure of claim 9, wherein said trailing leader line is comprised of a core material overcoated with a second, different material along its length.

13. The fishing lure of claim 12, wherein said core material is seven-strand wire, and said second material is a synthetic polymer.

14. The fishing lure of claim 9, wherein said trailing leader line comprises, at a distal end portion, at least one protuberance, and said tail section further comprises a hollow void in communication with said first hollow bore, wherein said hollow void has a substantially complementary shape to that of said at least one protuberance and is configured to receive said at least one protuberance therein.

15. The fishing lure of claim 14, wherein said protuberance is a resiliently-flexible barb.

16. The fishing lure of claim 15, wherein said resiliently-flexible barb is capable of shifting from a first, outwardly-splayed configuration in which said distal end portion of said trailing leader line can be lockingly engaged with said tail section, to a second, inwardly biased configuration that allows said distal end portion of said trailing leader line to be disengaged from said tail section.

17. A method of making a fishing lure, comprising:
providing a fishing lure body and a line attachment system, wherein said line attachment system comprises first and second juts formed from a length of wire; and
configuring said line attachment system substantially within said lure body such that a portion of said first jut and said second jut protrude from a forward portion of said lure body.

18. The method of claim 17, wherein said line attachment system further comprises first, second, and third rings, wherein said first ring loops through said first jut, said second ring loops through said second jut, and said third ring provides a line-to-lure attachment member that loops through said first and said second ring.

19. A fishing lure, comprising:
a lure body comprising a head section and a tail section;
attachment means providing coupling of fishing line to said lure body at said head section that engenders erratic motion of said lure when pulled through water; and
attachment means for reversibly attaching a trailing leader line to said tail section of said lure body.

20. The fishing lure of claim 0, wherein:
said attachment means providing coupling of fishing line to said lure is a line attachment system substantially disposed within said main lure body, comprising: first and second juts formed from a length of wire, a first attachment ring, a second attachment ring, and a third attachment ring; wherein a portion of said first and second juts protrudes from a forward portion of said head section; wherein said first attachment ring loops through said first jut, said second attachment ring loops through said second jut, and said third attachment ring loops through said first attachment ring and said second attachment ring; and
wherein said attachment means for reversibly attaching a trailing leader line to said tail section of said lure body comprises a first hollow bore within said tail section that extends to an end portion of said lure body and is configured to reversibly receive a portion of a trailing leader line.
